(19) United States
(12) Patent Application Publication
(10) Pub. No.: US 2025/0340306 A1
(43) Pub. Date: Nov. 6, 2025

(54) MONITORING A PROPULSION SYSTEM OF AN AIRCRAFT

(71) Applicant: SAFRAN HELICOPTER ENGINES, BORDES (FR)

(72) Inventors: David Bernard Martin LEMAY, MOISSY-CRAMAYEL (FR); Jean-Philippe Jacques MARIN, MOISSY-CRAMAYEL (FR); Romain Jean Gilbert THIRIET, MOISSY-CRAMAYEL (FR)

(73) Assignee: SAFRAN HELICOPTER ENGINES, BORDES (FR)

(21) Appl. No.: 18/998,617

(22) PCT Filed: Jul. 27, 2023
(86) PCT No.: PCT/FR2023/051197

§ 371 Date: Jan. 27, 2025

(30) Foreign Application Priority Data
Jul. 29, 2022 (FR) FR2207897

(51) Int. Cl. B64D 45/00; B64D 27/33

(52) U.S. Cl. CPC B64D 45/00; B64D 27/33

(57) ABSTRACT

A method for monitoring a propulsion system of an aircraft is provided. The method includes computing a margin of a parameter of a thermal chain, this margin being taken as the margin of the thermal chain computing a margin of a parameter of an electrical chain, at least part of this margin being taken as the margin of the electrical chain; adding together the margin of the thermal chain and the margin of the electrical chain to obtain a total margin of the propulsion system; and transmitting the total margin to a display device in the aircraft so that the display device displays the total margin.

### TECHNICAL FIELD OF THE INVENTION

The invention relates to hybrid propulsion systems for aircrafts, and more particularly to the parallel hybridisation of a helicopter.

### TECHNICAL BACKGROUND

A non-hybrid propulsion system typically comprises a thermal chain for driving a rotating propulsion unit of the aircraft, for example for driving the main rotor and the anti-torque rotor in the case of a helicopter.

The propulsion system has several certification speeds defining a power limit. It is known to compute an available power margin for each speed. To do this, a power margin is computed for several parameters in the thermal chain, and the smallest is selected.

The aircraft then comprises a flight control indicator designed to display synthetic information to the pilot, enabling him to know at any time the power margin available before reaching the power limits of the certified speeds. This indicator is called the First Limit Indicator (FLI) and informs the pilot of the remaining power margin.

In addition, a hybrid propulsion system comprises, in redundancy with the thermal chain, an electrical chain for driving the rotating propulsion unit. This redundancy allows the aircraft to land in satisfactory safety conditions in the event of a failure in the thermal chain. A characteristic application example is a parallel hybrid helicopter propulsion system, consisting of a turboshaft engine and an electric motor both driving the main and anti-torque rotors. However, the invention applies more generally to a hybrid aircraft propulsion system which does not necessarily have such rotors.

The aim of the invention is to adapt the computation of power margins to the case of a hybrid propulsion system.

### SUMMARY OF THE INVENTION

Therefore, a method for monitoring a propulsion system of an aircraft is proposed, the propulsion system comprising a rotating propulsion unit and a thermal chain for driving the rotating propulsion unit, the method comprising:
computing a threshold of a parameter of the thermal chain, below which this parameter must remain so that the thermal chain supplies a power lower than a predefined maximum power;
computing a margin of the parameter of the thermal chain with respect to its threshold, this margin being taken as the margin of the thermal chain;
   characterised in that, the propulsion system further comprising an electrical chain for driving the rotating propulsion unit in parallel with the thermal chain, the method also comprises:
computing a threshold of a parameter of the electrical chain, below which this parameter must remain so that the electrical chain supplies a power lower than a predefined maximum power;
computing a margin of the parameter of the electrical chain with respect to its threshold, at least part of this margin being taken as the margin of the electrical chain;
adding together the margin of the thermal chain and the margin of the electrical chain so as to obtain a total margin of the propulsion system; and
transmitting the total margin to a display device in the aircraft, so that the display device displays the total margin;
   and in that the propulsion system has at least one certified operating speed which defines a non-zero duration of power supply for the electrical chain, the method further comprising:
checking that an electrical storage source of the electrical chain is sufficiently charged so that the electrical chain can maintain the parameter with the smallest margin at its threshold for the defined power supply duration;

if the electrical storage source is sufficiently charged, the margin of the electrical chain is added to the margin of the thermal chain so as to obtain the total margin.

The invention may also comprise one or more of the following optional characteristics, in any technically possible combination.

Optionally, the method comprises:
computing, for each of several parameters of the electrical chain, a threshold below which this parameter must remain in order for the electrical chain to supply a power lower than a predefined maximum power;
computing, for each of the parameters of the electrical chain, a margin of the parameter with respect to its threshold,
determining the smallest of the margins of the parameters of the electrical chain, this smallest margin being taken as the margin of the thermal chain.

Also optionally, the propulsion system has at least one certified operating speed which defines a threshold for each of several parameters of the thermal chain, the method comprising:
computing a margin for each parameter of the electrical chain; and
determining the smallest of the margins of the parameters of the thermal chain, this smallest margin being taken as the margin of the thermal chain.

Also optionally, the method also comprises:
if the electrical storage source is not sufficiently charged, the overall margin is taken to be equal to the margin of the thermal chain.

Also optionally, if the electrical storage source is not sufficiently charged, the margin of the parameter is taken to be zero.

Also optionally, if the electrical storage source is not sufficiently charged, the margin of the parameter is taken to be equal to the state of charge divided by the predefined power supply duration.

Also optionally, the method also comprises transmitting the margin of the thermal chain to the display device to a pilot in the aircraft.

Also proposed is a computer program that can be downloaded from a communications network and/or recorded on a computer-readable medium, characterised in that it comprises instructions for executing the steps of a method according to the invention, when said program is executed on a computer.

It is also proposed an aircraft comprising:
A propulsion system of an aircraft, the propulsion system comprising a rotating propulsion unit and a thermal chain for driving the rotating propulsion unit;
a display device; and
a computer designed to implement a method according to the invention.

### BRIEF DESCRIPTION OF THE FIGURES

The invention will be better understood with the aid of the following description, given only by way of example and made with reference to the attached drawings wherein:

FIG. 1 is a functional view of an aircraft wherein the invention is implemented,

FIG. 2 is a block diagram of a method for monitoring a propulsion system of the aircraft shown in FIG. 1, and

FIG. 3 is a view of a first limit indicator for the aircraft in FIG. 1.

### DETAILED DESCRIPTION OF THE INVENTION

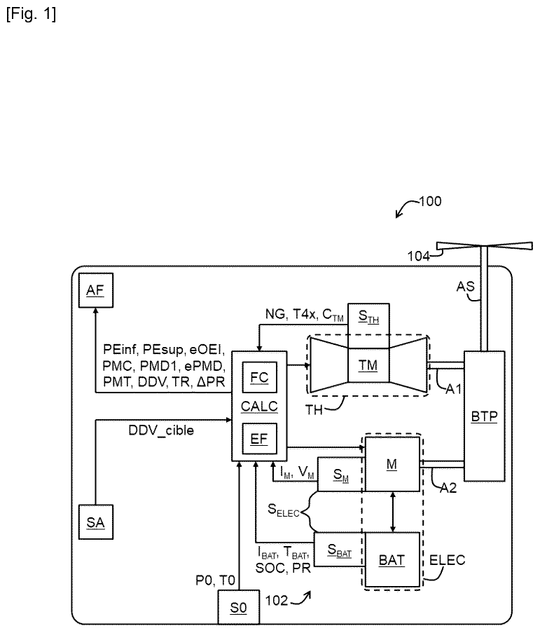

With reference to FIG. 1, an example of an aircraft 100 wherein the invention is implemented will now be described.

The aircraft 100 may be a fixed-wing or rotary-wing aircraft (as in the case of a helicopter), or a Vertical Take-Off & Landing aircrafts (VTOL).

The aircraft thus comprises a propulsion system 102.

The propulsion system 102 comprises at least one rotating propulsion unit 104. In the case of a helicopter, the propulsion system 102 comprises, for example, two rotating propulsion units: a main rotor designed to allow lift, control and propulsion, and an anti-torque rotor designed to counteract a torque induced by the main rotor. Alternatively, the rotating propulsion unit 104 can be a propeller or a fan.

The propulsion system 102 also comprises a thermal chain TH for driving each rotating propulsion unit 104. In the example shown, the TH thermal chain comprises a single turboshaft engine TM. Alternatively, the thermal chain TH could comprise several turboshaft engines.

Particularly in the case of a helicopter, the propulsion system 102 also comprises, for example, a main gearbox BTP comprising an input shaft A1 connected to the thermal chain TH and an output shaft AS connected to the rotating propulsion unit 104.

The propulsion system 102 also comprises an electrical chain ELEC for each rotating propulsion unit 104. The electrical chain ELEC comprises, for example, an electrical storage source BAT and an electrical machine M connected to the electrical storage source BAT. The electrical storage source BAT may comprise one or more elementary electrical sources, for example one or more chemical batteries or any other type of electrical energy storage device. Similarly, the electrical machine M may comprise one or more elementary electrical machines. The electrical machine M is 10 designed to operate selectively on the one hand, as a motor to receive electrical power from the electrical storage source BAT and, on the other hand, as a generator to supply electrical power to the electrical storage source BAT to recharge the latter. Alternatively, the electrical machine M can be designed to operate solely as a motor.

Due to the presence of the thermal chain TH and the electrical chain ELEC, the propulsion system 102 is thus described as hybrid.

In the case of so-called parallel hybridisation as illustrated, the main gearbox BTP comprises a second input shaft A2 connected to the electrical chain ELEC, in particular to the electrical machine M.

The aircraft 100 also comprises a computer CALC for controlling the propulsion system 102, more specifically the thermal chain TH and the electrical chain ELEC.

The propulsion system 102 has at least one certified operating speed. This means that the engine manufacturer guarantees, for each speed, that each of the thermal chain TH and the electrical chain ELEC is capable of supplying a maximum power (called limit) associated with that speed, possibly for a predefined duration associated with that speed. This duration is finite and may be zero. In the absence of an associated duration, the manufacturer guarantees that the maximum power can be reached for as long as required, and in any case for a very long duration, for example the typical duration of a mission.

The maximum power and the durations may be different for the thermal chain TH and for the electrical chain ELEC. So, in general, each speed defines, on the one hand, for the thermal chain TH, a maximum power and possibly a duration, and, on the other hand, for the electrical chain ELEC, a maximum power and possibly a duration.

Each limit can be “controlled”, i.e. indicative. It is then up to the pilot to comply with this limit according to the information in the user manual for the propulsion system 102. If the pilot requests more power than the piloted limit, the computer CALC is designed to allow the propulsion system 102 to exceed the piloted limit.

Each limit can alternatively be “controlled”, i.e. the computer CALC is designed to prevent them from being crossed, even if the pilot requests it to do so. The controlled limits are sometimes referred to as “stops”.

For example, the propulsion system 102 may have one or more of the following speeds.

The propulsion system 102 can have a continuous speed C, associated with a controlled limit PMC (Continuous Maximum Power) which is the maximum power that the thermal chain TH is capable of delivering continuously, i.e. over the entire duration of a mission, or even several missions of the aircraft 100.

The propulsion system 102 can have a maximum take-off speed D, associated with a piloted limit PMD_{TH} (PMD for Maximum Take-off Power) which is the power that the thermal chain TH can deliver for a predefined duration T_PMD_{TH} and with a piloted limit PMD_{ELEC} which is the power that the electrical chain ELEC can deliver for a predefined duration T_PMD_{ELEC}. The durations T_PMD_{TH} and T_PMD_{ELEC} are generally of the order of a few minutes (commonly of the order of fifteen to thirty minutes).

The propulsion system 102 can have a maximum transient speed T, associated with a controlled limit PMT_{TH} (PMT for Maximum Transient Power) which is the instantaneous maximum power that the thermal chain TH can deliver and a controlled limit PMT_{ELEC} which is the instantaneous maximum power that the electrical chain ELEC can deliver. For the maximum transient speed T, the duration for the thermal chain TH and the duration for the electrical chain are both zero.

To compute the different information to be displayed to the pilot, as will be explained in more detail later, the aircraft 100 comprises several measurement systems.

More specifically, the aircraft 100 firstly comprises a system STH for monitoring the thermal chain TH, designed to measure at least one parameter of the thermal chain TH having an impact on the power supplied by the thermal chain TH. For example, a speed NG of a gas generator of the turboshaft engine TM and/or a temperature T4x of the gas driving one or more power turbines of the turboshaft engine TM and/or a torque C_{TM} supplied by the turboshaft engine or engines of the thermal chain TH.

The aircraft 100 also comprises a system SELEC for monitoring the electrical chain ELEC, designed to measure at least one parameter of the electrical chain ELEC having an impact on the power supplied by the electrical chain ELEC.

The parameters having an impact on the power supplied by the thermal chain TH and the power supplied by the electrical chain ELEC are referred to below as the main parameters.

The measurement system S_{ELEC} comprises, for example, a system SBAT for measuring at least one parameter of the electrical storage source BAT, such as a current I_{BAT} supplied by the electrical storage source BAT to the electrical machine M and/or a state of charge SOC of the electrical storage source BAT. The measurement system S_{ELEC} comprises, for example, instead of or in addition to the measurement system S_{BAT}, a system SM for measuring at least one parameter of the electrical machine M, such as a torque CM supplied by the electrical machine M. The measurement system S_{ELEC} is also designed, for example, to measure at least one other so-called auxiliary parameter of the electrical chain ELEC, such as a temperature T_{BAT} of the electrical storage source BAT measured by the measurement system S_{BAT} and/or a charging power PR of the electrical storage source BAT. The charging power PR is computed, for example, from the current I_{BAT} of the electrical storage source BAT and a voltage measured at the terminals of the electrical storage source BAT.

The aircraft 100 also comprises, for example, an external monitoring system SO, designed to measure at least one atmospheric parameter around the aircraft 100, such as an atmospheric pressure P0 and/or an atmospheric temperature T0.

The aircraft 100 also comprises a display device AF designed to display the information transmitted by the computer CALC.

The aircraft 100 may also comprise an input device SA designed to allow the pilot to enter information for the computer CALC, in particular a target service life DDV_target. The input device SA can take a number of forms, such as an adjustment knob (potentiometer type) on an aircraft instrument panel, an input keyboard on a screen, and so on.

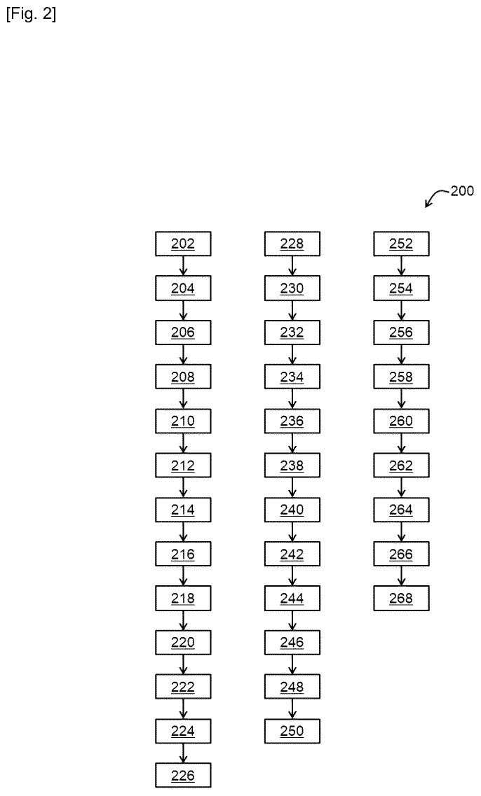

With reference to FIG. 2, an example of a method 200 according to the invention, for monitoring the propulsion system 102, will now be described.

During a step 202, the computer CALC receives a measurement of each parameter.

In the example shown, the computer CALC receives:
measurements NG_m, T4x_m, C_{TM_m} of the main parameters NG, T4x, C_{TM} of the thermal chain TH,
measurements I_{BAT_m}, C_{M_m} of the main parameters I_{BAT}. C_{M} of the electrical chain ELEC,
measurements T_{BAT_m}, SOC_m of the auxiliary parameters T_{BAT}, SOC of the electrical chain ELEC, and
measurements P0_m, T0_m of the atmospheric parameters P0, T0.

During a step 204, the computer CALC computes, for each speed and for each main parameter of the thermal chain TH, a threshold below which the main parameter in question must remain in order for the thermal chain TH to supply a power lower than the maximum power of the speed in question for the thermal chain TH. This computation is based, for example, on one or more other measured parameters, such as the atmospheric parameter(s).

In the example shown, the computer CALC computes, for example, from the measurements P0_m, T0_m:
for the continuous speed C, the thresholds NG_C, T4x_C and CTM_C,
for the take-off speed D, the thresholds NG_D, T4x_D and CTM D, and
for the transient speed T, the thresholds NG_T, T4x_T and CTM_T.

During a step 206, the computer CALC computes, for each speed and for each main parameter of the thermal source TH, a difference between the measurement and the threshold of the main parameter in question, this difference forming a margin of the main parameter in question.

In the example shown, the computer CALC computes:
for the continuous speed C, the margins ΔNG_C, ΔT4x_C and ΔC_{TM}_C,
for the take-off speed D, the margins ΔNG_D, ΔT4x_D and ΔC_{TM}_D, and
for the transient speed T, the margins ΔNG_T, ΔT4x_T and ΔC_{TM}_T.

In a step 208, the computer CALC computes, for each speed with a finite duration, possibly zero, and for each main parameter of the electrical chain ELEC, a threshold below which the main parameter in question must remain in order for the electrical chain ELEC to supply a power lower than the maximum power of the speed in question for the electrical chain ELEC. This computation is based, for example, on one or more other measured parameters, such as the atmospheric parameter(s).

In the example shown, the computer CALC computes, for example from the measurements SOC_m, T_{BAT}_m, P0_m and T0_m:
for the take-off speed D, the thresholds I_{BAT}_D and C_{M}_D, and
for the transient speed T, the thresholds I_{BAT}_T and C_{M}_T.

Thus, no threshold is computed for the continuous speed C for the electrical chain ELEC.

During a step 210, the computer CALC computes, for each speed with a finite duration, possibly zero, and for each main parameter of the electrical chain ELEC, a difference between the measurement and the threshold of the main parameter in question, this difference forming an intermediate margin of the main parameter in question.

In the example shown, the computer CALC computes:
for take-off speed D, the intermediate margins ΔI_{BAT}_D′ and ΔC_{M}_D′, and
for the transient speed T, the intermediate margins ΔI_{BAT}_T′ and ΔC_{M}_T′.

In step 212, the computer CALC converts the margins computed in steps 206 and 210 into the same unit, which may be that of any physical quantity. Preferably, this physical quantity is “meaningful” to the pilot and directly linked to his piloting. The unit chosen is power, for example, so that the margins are converted into power margins. Converted in this way, the margins can be compared and/or summed. The power is, for example, the mechanical power supplied.

For example, the current margin I_{BAT} can be expressed as power by multiplying it by a voltage of the electrical storage source BAT and by an efficiency of the electrical machine M.

Again, for example, the torque margin C_{M} can be expressed as power by multiplying it by the rotational speed of the electric machine M.

The parameters of the thermal chain TH, for example, can be converted into power using a model of the turboshaft engine TM and assuming all the other parameters of this engine to be constant.

In addition, during step 212, the thresholds of the main parameters of the electrical chain ELEC (the thresholds of the parameters IBAT and CM in the example shown) are also converted into the chosen unit, for example into power.

During a step 214, for each speed with a non-zero finite duration associated with the electrical chain ELEC, the computer CALC checks whether the electrical storage source BAT is sufficiently charged for the electrical chain ELEC to be able to supply the power threshold of this parameter, throughout the associated duration. In particular, to evaluate the charge of the electrical storage source BAT, it is possible to use, for example, the measurement SOC_m of the state of charge SOC of the electrical storage source BAT. Alternatively, a State Of Energy (SOE) measurement could be used.

For example, for the take-off speed D and for the current I_{BAT}, the computer CALC checks whether: SOC≥I_{BAT}_D×T_PMD_{ELEC}, I_{BAT}_D being expressed in power and T_PMD_{ELEC} being the maximum duration of the take-off speed D for the electrical chain. If the electrical storage source BAT is sufficiently loaded, then the margin of

the main parameter in question is taken to be equal to its intermediate margin. In this case, for example, the margin ΔI_{BAT}_D of the parameter I_{BAT} is taken to be equal to the intermediate margin ΔI_{BAT}_D′.

Otherwise, the margin of the main parameter in question is taken to be less than the intermediate margin.

In the first example, the parameter margin is taken to be zero. In this case, for example, if SOC<I_{BAT}_D×T_PMD_{ELEC}, the margin ΔI_{BAT}_D of the parameter I_{BAT} IS taken to be zero.

In a second example, if the electrical storage source BAT is not sufficiently charged, the parameter margin is taken to be equal to the state of charge SOC divided by the duration associated with the speed for the electrical chain ELEC. In this case, for example, if SOC <I_{BAT}_D×T_PMD_{ELEC}, the margin ΔI_{BAT}_D of the parameter I_{BAT} is taken to be equal to SOC/T_PMD_{ELEC}.

During a step 216, for each speed with an associated zero duration, the margin of the main parameter in question is then taken to be equal to its intermediate margin. In this case, for example, the margin AlBAT_T of the parameter I_{BAT} is taken to be equal to the intermediate margin AlBAT_T′.

During a step 218, when several parameters of the thermal chain TH are used, the computer CALC compares, for each speed, the margins of these parameters to select the smallest. The selected margin is taken as the margin of the thermal chain TH.

For example, the margin of the thermal chain TH is noted PMC for the continuous speed C, PMD1 for the take-off speed D and PMT1 for the transient speed T.

During a step 220, when several parameters of the electrical chain ELEC are used, the computer CALC compares, for each speed, the margins of these parameters in order to select the smallest.

For example, the margin of the electrical chain ELEC is noted ΔP_{ELEC}_PMD for the take-off speed D and ΔP_{ELEC}_PMT for the transient speed T.

During a step 222, the computer CALC adds, for each speed, the smallest margin for the thermal chain TH with the smallest margin for the electrical chain ELEC, this addition forming a total margin for the propulsion system 102 for the speed in question.

For example, the total margin is ePMD for the take-off speed D and is equal to: ePMD=PMD1+ΔP_{ELEC}_PMD. In a similar way, the total margin is noted ePMT for the transient speed T and is equal to: ePMT=PMT1+ΔP_{ELEC}_PMT

During a step 224, the computer CALC transmits the total margin associated with each speed to the display device AF. In addition, the computer CALC can transmit, for each speed, the margin for the thermal chain TH alone (without the electrical chain ELEC).

In the example shown, the computer CALC transmits the margin ePMD and the margin PMD1 for the take-off speed D and the margin ePMT for the transient speed T. For the continuous speed C, the computer CALC transmits the margin PMC.

In a step 226, the display device AF displays the margins received. It also displays the total power supplied by the propulsion system 102.

Furthermore, during flight, the computer CALC is designed so that the power supplied by the propulsion system 102 is allocated as a priority to the needs of the aircraft ahead of recharging the electrical storage source BAT (e.g. the power required by the main and anti-torque rotors to carry out the manoeuvre commanded by the pilot). When the power supplied by the thermal chain TH falls, recharging of the electrical storage source BAT is reduced to ensure that power is available to the pilot. This operation can be carried out automatically so that the pilot only has to worry about the flight. In this case, however, it may be useful to provide the pilot with summary information to help him manage the recharging of the electrical storage source BAT when the flight conditions allow (e.g. in cruise flight or during descent on the approach to landing).

To do this, during a step 228, the computer CALC computes a maximum charging power for the electrical storage source BAT, for example from measured parameters such as the state of charge SOC of the electrical storage source BAT, the temperature T_{BAT} of the electrical storage source BAT and the atmospheric temperature T0. This maximum charging power is computed, for example, by a mathematical function or a table of values depending on the relevant parameters and stored in a memory accessible by the computer CALC. This limit can be expressed as a power (in Watts), an electric current or any other quantity or unit of measurement chosen by the designer.

In a step 230, the computer CALC receives a measurement of a charging power PR from the electrical storage source BAT.

In a step 232, the computer CALC computes a difference between the charging power measurement PR and the maximum charging power, this difference forming an instantaneous charging power margin ΔPR.

In a step 234, the computer CALC transmits the instantaneous charging power margin ΔPR to the display device AF.

In a step 236, the display device AF displays the instantaneous charging power margin ΔPR to the pilot.

In a step 238, the computer CALC computes a difference between a target state of charge SOC* and a measure SOC_m of the state of charge SOC, this difference forming an energy remaining to be recharged. The state of charge SOC can be measured using measurements of parameters of the electrical storage source BAT (for example, the voltage at its terminals and the current I_{BAT}) and a mathematical model of the latter.

In a step 240, the computer CALC computes a maximum charging power profile for the electrical storage source BAT up to the target state of charge SOC* This profile can be computed using measurements of parameters of the electrical storage source BAT (for example, the voltage at its terminals and the current I_{BAT}) and a mathematical model of the latter.

In a step 242, the computer CALC receives a measurement of the charging power PR from the electrical storage source BAT.

During a step 244, the computer CALC computes a charging power profile by selecting for each point the minimum between the maximum charging power profile and the current power.

In a step 246, the computer CALC computes a remaining recharge time TR as the integral of the ratio between the energy remaining to be charged and the charging power profile. In practice, this integral can be computed by the control system as the sum of the intervals of the discretised power trajectory.

In a step 248, the computer CALC transmits the remaining recharge time TR to the display device AF.

In a step 250, the display device AF displays the remaining recharge time TR.

In addition, the turboshaft engine TM has a service life (or conversely, a rate of damage) that depends on its power demands. This service life depends mainly on the rotational speed of the rotating assemblies (for example, the speed NG of the gas generator, free turbine, etc.): NTL/N2), and temperature T4x.

Two damage modes are generally taken into account: the cyclic fatigue and the creep.

The computer CALC comprises a cyclic fatigue counter FC and a creep counter EF.

The cyclic fatigue is induced by the mechanical stress caused by the centrifugal acceleration undergone by rotating assemblies (compressor or compressors, HP turbine or turbines, LP turbine or turbines).

The cyclic fatigue counter FC is designed to count cycles of variation of speed NG over time. These cycles generally comprise, for each mission (i.e. the period during which the aircraft is switched on), a main cycle between start-up (zero speed NG) and the maximum mission speed, as well as partial cycles during the mission.

For example, the cyclic fatigue counter FC is designed to compute, at each time step, an increment dC_FC from a measurement NG_m of the speed NG at that time step and from a history of measurements of the speed NG, by implementing a predefined damage law f1: dC_FC=f1(NG_m, previous measurements).

The creep characterises the expansion of the turbine blades on the turboshaft engine TM. The creep is caused by the combined effect of centrifugal acceleration and the high temperature to which rotating parts are subjected. It therefore depends on the power the pilot requires from the engine and the atmospheric conditions PO, TO.

The creep counter EF is designed to compute, at each time step, an increment dC_EF from a measurement NG_m of the speed NG and a measurement T4x_m of the temperature T4x at that time step, implementing a predefined damage law f2: dC_EF=f2(NG_m, T4x_m).

When one of the counters FC, EF reaches a predefined threshold (noted C_FC_max for the cyclic fatigue counter FC and C_EF_max for the creep counter EF), maintenance of the turboshaft engine TM must be performed.

To allow the pilot to manage his flight to achieve a desired service life, the following steps can be implemented.

In a step 252, the input device SA receives the target service life DDV_target from the propulsion system 102, and transmits it to the computer CALC. The target service life DDV_target is entered by the pilot, for example, and can be adjusted before each flight, depending on a compromise between the aircraft's operating cost and the service provided on the mission (on-board load and flight duration).

During a step 254, the computer CALC receives the target service life DDV_target.

In a step 256, the computer CALC computes, for each counter FC, EF, a maximum incrementation rate of the counter FC, EF that remains below a predefined threshold throughout the target service life DDV_target.

In a first example, the maximum incrementation rate is computed assuming linear wear over the entire target service life DDV_target. Thus, the maximum incrementation rate dC_FC_max of the cyclic fatigue counter FC is given by: dC_FC_max=C_FC_max/DDV_target and the maximum incrementation rate dC_EF_max of the creep counter EF is given by: dC_EF_max=C_EF_max/DDV_target. The maximum incrementation rates are therefore constant as long as the target service life DDV_target is not modified.

In a second example, each maximum incrementation rate is computed “dynamically”, based on the past use of the turboshaft engine TM. In this way, each maximum incrementation rate is computed by considering linear wear from the current situation, current counter value FC, EF and elapsed part DDV_of the target service life DDV_target. The maximum incrementation rate dC_FC_max of the cyclic fatigue counter FC is given by: dC_FC_max=(C_FC_max−C_FC_current)/DDV_target−DDV_run) and the maximum incrementation rate dC_EF_max of the creep counter EF is given by: dC_EF_max=(C_EF_max−C_EF_current)/DDV_target−DDV_run). It will be appreciated that DDV_target−DDV_run equals the remaining service life, noted DDV.

In this way, if the turboshaft engine is regularly used at high power levels at the start of the mission (for example: use at a power level close to power PMD on take-off and during climb), the maximum incrementation rate is adapted downwards to encourage the pilot to use the turboshaft engine TM less for the rest of the flight.

In a step 258, the computer CALC computes a threshold NGmax_FC for the speed NG from the function f1 of the cyclic fatigue counter FC and the maximum incrementation rate of the cyclic fatigue counter FC. More specifically, the threshold NGmax_FC is computed by applying the inverse damage law f1⁻¹ to the maximum incrementation rate dC_FC_max, with knowledge of the measurement history: NGmax_FC=f1⁻¹ (dC_FC_max).

During a step 260, the computer CALC computes a threshold NGmax_EF for the speed NG and a threshold T4xmax_EF for the temperature T4xmax, from the function f2 of the creep counter EF and the maximum incrementation rate of the creep counter EF. More specifically, the NGmax_EF threshold and the T4xmax_EF threshold are computed by applying the inverse damage law f2⁻¹ to the maximum increment inverse damage law f21: (NGmax_EF, T4xmax_EF)=f2⁻¹(dC_EF_max). It will be appreciated that, as the speed NG and the temperature T4x are linked to each other by the operation of the turboshaft engine TM, the inverse damage law f21 gives only one possible combination of NGmax_EF, T4xmax_EF.

During a step 262, the computer CALC computes, on the basis of the thresholds NGmax_FC, NGmax_EF, T4xmax_EF and with the aid of a model of the turboshaft engine TM, an upper limit PEsup of an operating variable of the turboshaft engine TM, for example a power supplied by the turboshaft engine TM.

For example, the computer CALC computes, as the upper limit PEsup, the mechanical power that the turboshaft engine TM can deliver without exceeding these thresholds NGmax_FC, NGmax_EF, T4xmax_EF, using a model of the turboshaft engine TM.

In a step 264, the computer CALC computes a lower limit PEinf using the damage law in partial cycles.

For example, the computer CALC computes, as the lower limit PEinf, the mechanical power that the turboshaft engine TM can deliver without falling below this threshold NGmin_FC, T4xmax_EF (apart from a shutdown of the turboshaft engine TM), using a model of the turboshaft engine TM.

In a step 266, the computer CALC transmits to the display device AF a current value of the mechanical power supplied by the propulsion system 102, the lower limit PEinf and the upper limit PEsup.

In a step 268, the display device AF displays the current value of the mechanical power supplied, the lower limit PEinf and the upper limit PEsup.

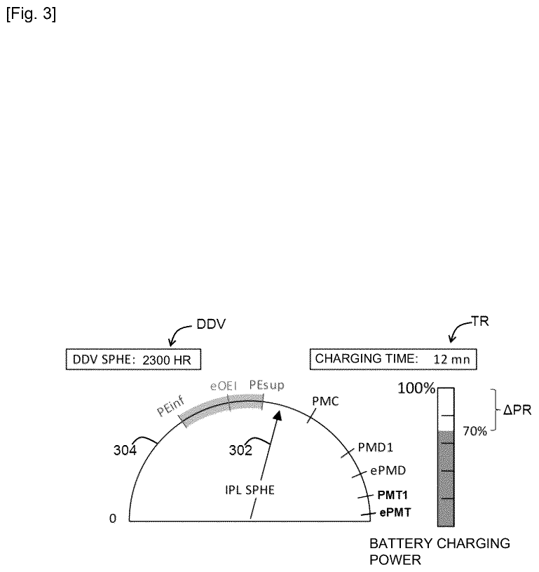

With reference to FIG. 3, an example of the display device AF is illustrated.

In this example, the power supplied by the system is indicated by a rotating needle 302.

The margins PMC, PMD1, ePMD, PMT1,ePMT are indicated as markers along a stroke 304 of the rotating needle 302, as are the lower limit PEinf and the upper limit PEsup.

It will be further noted that the invention is not limited to the embodiments described above. In fact, it will appear to the person skilled in the art that various modifications can be made to the above-described embodiments, in the light of the teaching just disclosed.

In the foregoing detailed presentation of the invention, the terms used should not be interpreted as limiting the invention to the embodiments exposed in the present description, but should be interpreted to include all equivalents the anticipation of which is within the reach of the person skilled in the art by applying his general knowledge to the implementation of the teaching just disclosed.

1. A computer-implemented method for monitoring a propulsion system of an aircraft , the propulsion system having a rotating propulsion unit, and a thermal chain for driving the rotating propulsion unit , and an electrical chain for driving the rotating propulsion unit in parallel with the thermal chain, the method comprising:
computing a first threshold of a thermal parameter of the thermal chain , the first threshold below which this the thermal parameter must remain so that the thermal chain supplies a power lower than a predefined maximum power;
computing a first margin of the thermal parameter of the thermal chain with respect to its the first threshold, the first margin being taken as the margin of the thermal chain;
computing a second threshold of an electrical parameter of the electrical chain , the second threshold below which this the electrical parameter must remain so that the electrical chain supplies a power lower than a predefined maximum power;
computing a second margin of the electrical parameter of the electrical chain with respect to its the second threshold, at least part of the second margin being taken as the margin of the electrical chain;
adding together the first margin and the second margin to obtain a total margin of the propulsion system; and
transmitting the total margin to a display device in the aircraft, so that the display device displays the total margin,
wherein the propulsion system has at least one certified operating speed which defines a non-zero duration of power supply for the electrical chain, and wherein the method further comprises:
checking that an electrical storage source of the electrical chain is sufficiently charged so that the electrical chain can maintain the electrical parameter with the smallest margin at the second threshold during the defined power supply duration; and
if the electrical storage source is sufficiently charged, adding the second margin to the first margin to obtain the total margin.

2. The method according to claim 1, further comprising:
computing, for each of several parameters of the electrical chain, a third threshold, below which the parameters must remain in order for the electrical chain to supply a power lower than a predefined maximum power;
computing, for each of the parameters of the electrical chain, a third margin with respect to the third threshold; and
determining the smallest of the third margins of the electrical chain, this the smallest of the third margins being taken as the margin of the electrical chain

3. The method according to claim 1, wherein the propulsion system has at least one certified operating speed which defines a fourth threshold for each of several parameters of the thermal chain the method further comprising:
computing a fourth margin for each parameter of the thermal chain and
determining the smallest of the fourth margins of the parameters of the thermal chain, the smallest fourth margin being taken as the margin of the thermal chain.

4. The method according to claim 1, further comprising:
if the electrical storage source is not sufficiently charged, the overall margin is taken to be equal to the margin of the thermal chain.

5. The method according to claim 1, wherein, if the electrical storage source is not sufficiently charged, the second margin of the electrical parameter is taken to be zero.

6. The method according to claim 1, wherein, if the electrical storage source is not sufficiently charged, the second margin of the electrical parameter is taken to be equal to the state of charge divided by the predefined power supply duration.

7. The method according to claim 1, further comprising transmitting the first margin of the thermal chain to the display device to a pilot in the aircraf .

8. A computer program which can be downloaded from a communications network and/or recorded on a computer-readable medium, the computer program comprising instructions for executing the steps of a method according to claim 1, when said the program is executed on a computer.

9. An aircraft, comprising:
a propulsion system having a rotating propulsion unit , a thermal chain for driving the rotating propulsion unit , and an electrical chain for driving the rotating propulsion unit in parallel with the thermal chain
a display device; and
a computer configured to implement:
computing a first threshold of a thermal parameter of the thermal chain , the first threshold below which the thermal parameter must remain so that the thermal chain supplies a power lower than a predefined maximum power;
computing a first margin of the thermal parameter with respect to the first threshold, this the first margin being taken as the margin of the thermal chain;
computing a second threshold of an electrical parameter of the electrical chain , the second threshold below which this the electrical parameter must remain so that the electrical chain supplies a power lower than a predefined maximum power;
computing a second margin of the electrical parameter with respect to the second threshold, at least part of the second margin being taken as the margin of the electrical chain;
adding together the first margin and the second margin to obtain a total margin of the propulsion system; and
transmitting the total margin to the display device in the aircraft , so that the display device displays the total margin,
wherein the propulsion system has at least one certified operating speed which defines a non-zero duration of power supply for the electrical chain, the computer being further configured to implement:
checking that an electrical storage source of the electrical chain is sufficiently charged so that the electrical chain can maintain the electrical parameter with the smallest second margin at its the second threshold during the defined power supply duration; and
if the electrical storage source is sufficiently charged, the second margin of the electrical chain ELEC is added to the first margin to obtain the total margin.
